(19) United States
(12) Patent Application Publication
(10) Pub. No.: US 2026/0194630 A1
(43) Pub. Date: Jul. 9, 2026

(54) LIGHT TRANSCEIVING MODULE AND LIDAR

(71) Applicant: SUTENG INNOVATION TECHNOLOGY CO., LTD., Shenzhen (CN)

(72) Inventors: Kang Liu, Shenzhen (CN); Yifei Wang, Shenzhen (CN); Xu You, Shenzhen (CN)

(73) Assignee: SUTENG INNOVATION TECHNOLOGY CO., LTD., Shenzhen (CN)

(21) Appl. No.: 19/442,751

(22) Filed: Jan. 7, 2026

(30) Foreign Application Priority Data
Jan. 8, 2025 (CN) 202510035346.3

(51) Int. Cl. G01S 7/481

(52) U.S. Cl. CPC G01S 7/4811; G01S 7/4817

(57) ABSTRACT

A light transceiving module and a LiDAR are provided. The light transceiving module includes a light emitting assembly, a light receiving assembly, and a beam splitter. The beam splitter has a transparent region for detecting light to pass through and a deflecting region for deflecting echo light, so as to separate a light emitting channel from a light receiving channel. The emitting aperture of the light emitting assembly is r1, and the receiving aperture of the light receiving assembly is r2. At the beam splitter, the optical axis of the light emitting assembly is located on the front side of the optical axis of the light receiving assembly, and a vertical spacing between the optical axis of the light emitting assembly and that of the light receiving assembly is L, wherein r1<r2, and 0<L<r1+r2.

### CROSS REFERENCE TO RELATED APPLICATION

The present application claims the benefit of priority to Chinese Patent Application No. 202510035346.3, filed on Jan. 8, 2025, which is hereby incorporated by reference in its entirety.

### TECHNICAL FIELD

The present application relates to the field of LiDAR technology, and more specifically, to a light transceiving module and a LiDAR.

### BACKGROUND

LiDAR is widely used in fields such as unmanned driving, vehicle-road collaboration, and unmanned exploration due to its advantages such as active detection, strong anti-interference capability, long ranging distance, and real-time feedback of the distance and speed of a target object. Among them, when the LiDAR has a large size, its application scenarios will be limited.

### SUMMARY

Embodiments of the present application provide a light transceiving module and a LiDAR, which can solve the problem that the large size of the LiDAR limits its application range.

In a first aspect, an embodiment of the present application provides a light transceiving module for a LiDAR. The light transceiving module comprising: a light emitting assembly, configured to emit detecting light toward a target object along a light emitting channel; a light receiving assembly, configured to receive echo light formed by reflection of the detecting light from the target object along a light receiving channel; and a beam splitter, having a transparent region through which the detecting light passes and a reflective region that deflects the echo light, and configured to separate the light emitting channel and the light receiving channel; wherein, an emitting aperture of the light emitting assembly is r1, a receiving aperture of the light receiving assembly is r2, at the beam splitter, an optical axis of the light emitting assembly is located at a front side of an optical axis of the light receiving assembly, a vertical distance between the optical axis of the light emitting assembly and the optical axis of the light receiving assembly is L, r1<r2, and 0<L<r1+r2.

In some embodiments, the light transceiving module comprises a first aperture stop, the first aperture stop being positioned on the light emitting channel of the beam splitter facing away from the light emitting assembly, wherein the emitting aperture of the light emitting assembly is an aperture of the first aperture stop; and the light transceiving module comprises a second aperture stop, the second aperture stop being positioned on the light receiving channel spaced apart from the light emitting channel, wherein the receiving aperture of the light receiving assembly is an aperture of the second aperture stop.

In some embodiments, the light transceiving module satisfies: r2−r1<L<r2.

In some embodiments, the transparent region and the reflective region partially overlap; the beam splitter has a front edge, a distance from an edge of the transparent region to the front edge is s1, a distance from an edge of the reflective region to the front edge of the beam splitter is s2, s1<s2, and 0 mm≤s1≤5 mm.

In some embodiments, at least a part of the light emitting channel is arranged along a first direction, and the beam splitter is disposed on the part of the light emitting channel arranged along the first direction; and a part of the light receiving channel is arranged along the first direction, and the echo light projected along the first direction is deflected by the beam splitter into the light receiving channel to propagate along a second direction at an angle to the first direction toward the light receiving assembly, so as to separate another part of the light receiving channel from the light emitting channel.

In some embodiments, the light emitting assembly comprises a light emitter, an emitting lens group, and an emitting reflector, the light emitter is configured to emit detecting light along the second direction; the emitting lens group and the emitting reflector are respectively disposed on the light emitting channel between the light emitter and the beam splitter, the emitting reflector is configured to deflect the detecting light emitted by the light emitter along the second direction and project the deflected detecting light along the first direction to the beam splitter; and the light receiver is configured to receive the echo light projected along the second direction after being deflected by the beam splitter, and the receiving lens group is disposed on the light receiving channel between the light receiver and the beam splitter.

In some embodiments, the emitting reflector is disposed on the light emitting channel between the beam splitter and the emitting lens group; or, the emitting reflector is disposed between two adjacent lenses of the emitting lens group; or, the emitting reflector is disposed on the light emitting channel between the light emitter and the emitting lens group.

In some embodiments, the light emitting assembly comprises a light emitter and an emitting lens group, the light emitter is configured to emit detecting light along the first direction, and the emitting lens group is disposed on the light emitting channel between the light emitter and the beam splitter; the light receiving assembly comprises a light receiver and a receiving lens group, the receiving lens group is disposed on the light receiving channel between the light receiver and the beam splitter; and the light receiver is configured to receive the echo light projected along the second direction after being deflected by the beam splitter.

In some embodiments, the light emitting assembly comprises a light emitter and an emitting lens group, the light emitter is configured to emit detecting light along the first direction, and the emitting lens group is disposed on the light emitting channel between the light emitter and the beam splitter; the light receiving assembly comprises a light receiver and a receiving lens group, the receiving lens group is disposed on the light receiving channel between the light receiver and the beam splitter; and the light receiver further comprises a receiving reflector, the receiving reflector is disposed on the light receiving channel between the light receiver and the beam splitter, and the receiving reflector is configured to deflect the echo light projected along the second direction after being deflected by the beam splitter to be projected along the first direction to the light receiver.

In a second aspect, the present application provides a LiDAR, comprising the light transceiving module and a light scanning device having a working surface facing a field of view; wherein the working surface is configured to deflect the detecting light passing through the beam splitter to the field of view for scanning, and also configured to receive the echo light and deflect the echo light to the beam splitter.

Based on the light transceiving module and the LiDAR of the embodiments of the present application, the light emitting assembly and the light receiving assembly of the light transceiving module are in a slightly off-axis state, so that the detecting light passes through the beam splitter in a region deviating from the center of the beam splitter. When the light transceiving module disclosed in the embodiments of the present application is applied to a LiDAR, the probability that the detecting light is reflected by the beam splitter to form stray light can be reduced. It can not only meet the demand for short-distance detection, but also, compared with a coaxial optical path scheme, shorten the distance between the beam splitter and the light scanning device to compress the volume of the LiDAR; compared with an off-axis optical path scheme, reduce the size of the working surface of the light scanning device used for deflecting the detecting light and the echo light. The load and size of the drive motor for driving the movement of the working surface are both reduced, and the noise is also reduced. Secondly, in the present application, the spot offset of the echo light arriving at the light receiving assembly is small, reducing the influence of the spot offset on the detection effect of the LiDAR. In addition, in the present application, the size of the light receiving assembly is between that of the coaxial optical path scheme and the off-axis optical path scheme, the production and assembly difficulty of the light receiving assembly is moderate, facilitating mass production.

### BRIEF DESCRIPTION OF DRAWINGS

FIG. 1a is a schematic diagram of the relative positional relationship between the emitting aperture and the receiving aperture in a coaxial optical path scheme;

FIG. 1b is a schematic diagram of the positional relationship where the emitting aperture and the receiving aperture of a coplanar off-axis optical path scheme are arranged side by side along a horizontal direction;

FIG. 1c is a schematic diagram of the positional relationship where the emitting aperture and the receiving aperture of a coplanar off-axis optical path scheme are arranged side by side along a vertical direction;

FIG. 1d is a schematic diagram of the positional relationship where the emitting aperture and the receiving aperture of a non-coplanar off-axis optical path scheme are arranged side by side along a vertical direction;

FIG. 2a is a schematic diagram of the light path deflected by the light scanning device for detecting light and echo light in a coaxial optical path scheme;

FIG. 2b is a schematic diagram of the light path deflected by the light scanning device for detecting light in a coaxial optical path scheme;

FIG. 3a is a schematic diagram of the light path deflected by the light scanning device for detecting light and echo light in an off-axis optical path scheme;

FIG. 3b is a schematic diagram of the light path deflected by the light scanning device for detecting light in an off-axis optical path scheme;

FIG. 3c is a schematic diagram of the light path where echo light deviates from the receiving center in an off-axis optical path scheme;

FIG. 4 is a structural schematic diagram of a light transceiving module corresponding to the arrangement of a light scanning device in an embodiment of the present application;

FIG. 5 is a schematic diagram of the light path of a light transceiving module in an embodiment of the present application;

FIG. 6 is a structural schematic diagram of a beam splitter laid flat in an embodiment of the present application;

FIG. 7 is a structural schematic diagram of a light transceiving module when a light emitter emits detecting light along a first direction in an embodiment of the present application;

FIG. 8 is a structural schematic diagram of a light transceiving module when a light emitter emits detecting light along a first direction in another embodiment of the present application;

FIG. 9 is a structural schematic diagram of an emitting lens group in an embodiment of the present application;

FIG. 10 is a field curvature curve diagram of the emitting lens group in an embodiment of the present application;

FIG. 11 is a modulation transfer function (MTF) curve diagram of the emitting lens group in an embodiment of the present application;

FIG. 12 is a full-field spot diagram of the emitting lens group in an embodiment of the present application;

FIG. 13 is a structural schematic diagram of a receiving lens group in an embodiment of the present application;

FIG. 14 is a field curvature curve diagram of the receiving lens group in an embodiment of the present application;

FIG. 15 is an MTF curve diagram of the receiving lens group in an embodiment of the present application;

FIG. 16 is a full-field spot diagram of the receiving lens group in an embodiment of the present application.

### REFERENCE NUMBER

20′: light scanning element;
r1′: outgoing aperture;
r2′: incoming aperture;
1: LiDAR;
10: light transceiving module;
20: light scanning device;
21: working surface;
100: light emitting assembly;
110: light emitter;
120: emitting lens group;
130: emitting reflector;
200: light receiving assembly;
210: light receiver;
220: receiving lens group;
230: receiving reflector;
300: beam splitter;
310: transparent region;
320: reflective region;
301: front edge;
410: first aperture stop;
420: second aperture stop;
A: first direction;
B: second direction.

### DETAILED DESCRIPTION

To make the object, technical solutions, and advantages of the present application clearer, the present application is further described in detail below in conjunction with the drawings and embodiments. It should be understood that the specific embodiments described herein are merely for explaining the present application and are not intended to limit the present application.

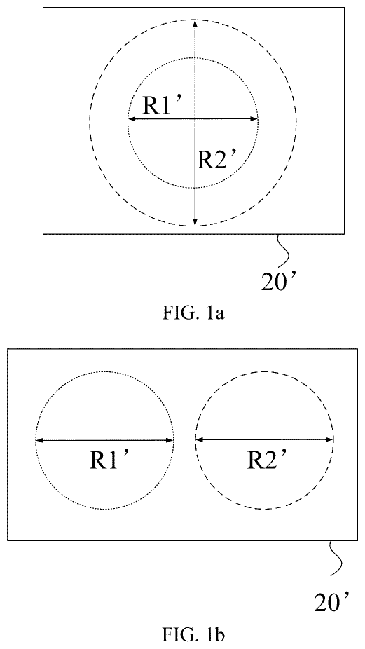

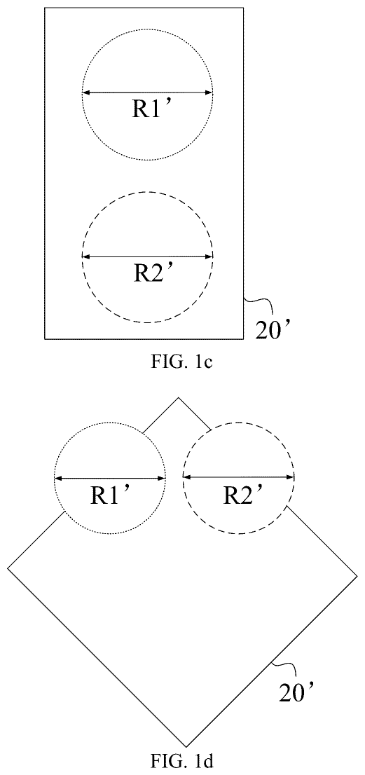

The light transceiving module of a LiDAR includes a light emitting assembly, a light receiving assembly, and a light scanning element 20′. The light scanning element 20′ is configured to deflect the detecting light emitted by the light emitting assembly to a target object in the field of view for scanning, and also configured to receive the echo light reflected back from the target object and deflect the echo light to project it to the light receiving assembly. Herein, the schemes for transmitting and receiving light by the light emitting assembly and the light receiving assembly mainly include a coaxial optical path scheme and an off-axis optical path scheme. As shown in FIG. 1a, it is a schematic diagram of the relative positional relationship between the outgoing aperture r1′ of the light emitting assembly and the incoming aperture r2′ of the light receiving assembly in the coaxial optical path scheme. The outgoing aperture r1′ of the light emitting assembly is the aperture of the minimum light-transmitting hole of the light emitting assembly (for convenience of labeling, all apertures in the drawings are labeled with diameter R1′, where r1′=R1′). The incoming aperture r2′ of the light receiving assembly is the aperture of the minimum light-transmitting hole of the light receiving assembly (for convenience of labeling, all apertures in the drawings are labeled with diameter R2′, where r2′=R2′). As shown in FIG. 1b, it is a schematic diagram of the positional relationship where the outgoing aperture r1′ of the light emitting assembly and the incoming aperture r2′ of the light receiving assembly in the coplanar off-axis optical path scheme are arranged side by side along a horizontal direction. As shown in FIG. 1c, it is a schematic diagram of the positional relationship where the outgoing aperture r1′ of the light emitting assembly and the incoming aperture r2′ of the light receiving assembly in the coplanar off-axis optical path scheme are arranged side by side along a vertical direction. As shown in FIG. 1d, it is a schematic diagram of the positional relationship where the outgoing aperture r1′ of the light emitting assembly and the incoming aperture r2′ of the light receiving assembly in the non-coplanar off-axis optical path scheme correspond to different scanning surfaces of the light scanning element 20′.

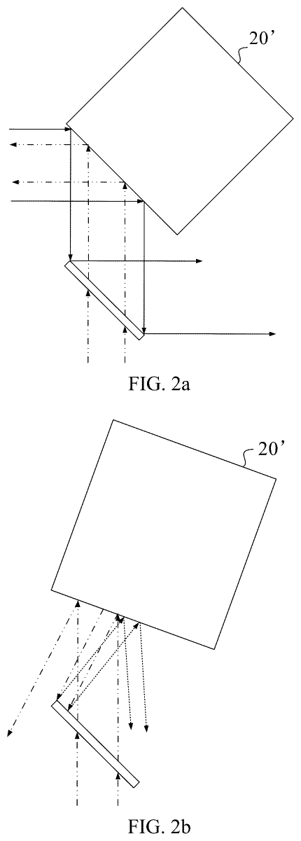

In the coaxial optical path scheme, the distance between the optical axis of the light emitting assembly and the optical axis of the light receiving assembly at the light scanning element 20′ is zero, and there is no problem of short-distance spot offset. The size requirement for the light scanning element 20′ is lower. However, as shown in FIG. 2a, the disadvantage of the coaxial optical path scheme is that the outgoing aperture r1′ of the light emitting assembly occupies the incoming aperture r2′ of the light receiving assembly, resulting in a large incoming aperture r2′ of the light receiving assembly, difficult design, and high cost. Moreover, to meet the demand for a large light-receiving area, the size of the incoming aperture r2′ of the light receiving assembly is designed to be larger, and the outgoing aperture r1′ of the emitting assembly is located in the central region of the incoming aperture r2′ of the light receiving assembly. As shown in FIG. 2b, when the detecting light emitted by the light emitting assembly is projected onto the light scanning element 20′, part of the detecting light is reflected back by the light scanning element 20′ and projected again onto other components of the light transceiving module to form stray light. The closer the distance from the light transceiving module to the light scanning element 20′, the higher the probability of generating stray light. Therefore, it is necessary to increase the distance between the light transceiving module and the light scanning element 20′, making it difficult to make the entire LiDAR compact.

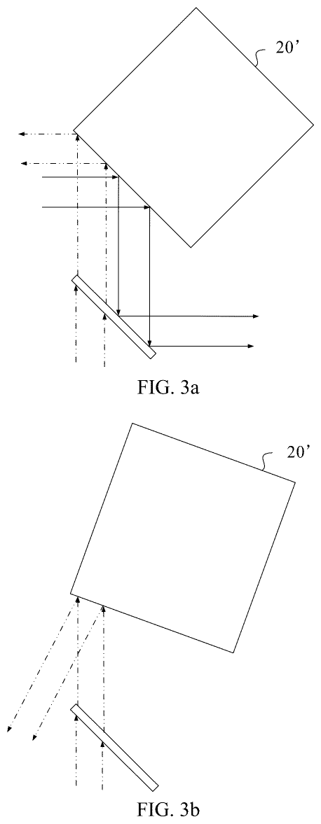

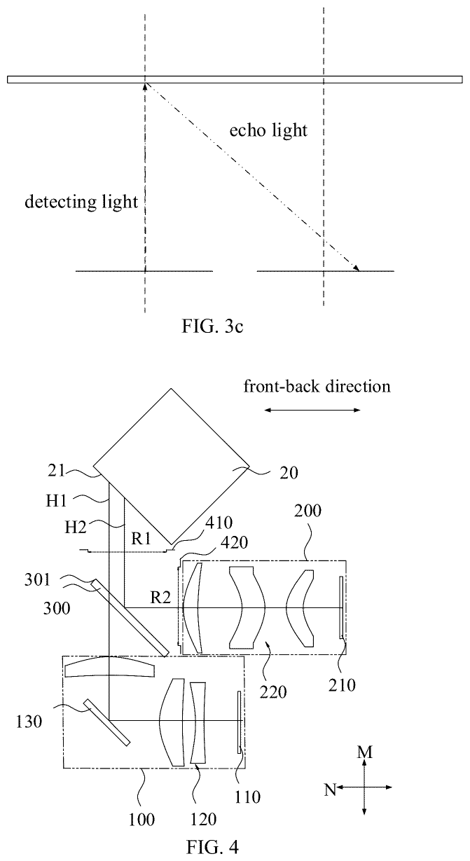

In the off-axis optical path scheme, the advantage is that the light transmitting and receiving paths of the light transceiving module are physically isolated. The light receiving assembly has a sufficient incoming aperture r2′ to receive echo light, with smaller demand for the incoming aperture r2′ and easier design. Moreover, as shown in FIGS. 3a and 3b, when the detecting light emitted by the light emitting assembly is projected onto the light scanning element 20′, the light path of the detecting light is located on one side of the light path of the echo light. After being reflected by the light scanning element 20′, the detecting light is less likely to be blocked by other components of the light transceiving module, resulting in a low probability of stray light generation. Therefore, the distance between the light transceiving module and the light scanning element 20′ can be reduced, making the overall structure of the LiDAR compact. However, due to the physical isolation of the light emitting assembly and the light receiving assembly and the large vertical distance between their optical axes, the light receiving assembly is prone to severe spot offset when receiving echo light, affecting the detection effect of the LiDAR. As shown in FIG. 3c, it is a schematic diagram of the light path where the echo light formed by reflection of the central detecting light from the target object deviates from the receiving center of the light receiver upon arrival. In addition, to meet the requirements for transmitting and receiving detecting light and echo light, the size of the scanning device needs to be larger—specifically, the size of the working surface of the scanning device for deflecting light needs to be larger. A larger working surface requires a drive motor with a greater load to rotate the working surface and also affects the overall volume of the LiDAR.

Based on the above schemes, an embodiment of the present application provides a light transceiving module and a LiDAR, which can reduce the size of the transceiving module and the LiDAR while improving the problem of short-distance spot offset.

The LiDAR includes a light transceiving module, a light scanning device, and a housing. The light transceiving module and the light scanning device are both disposed in the internal space of the housing and mounted on the housing.

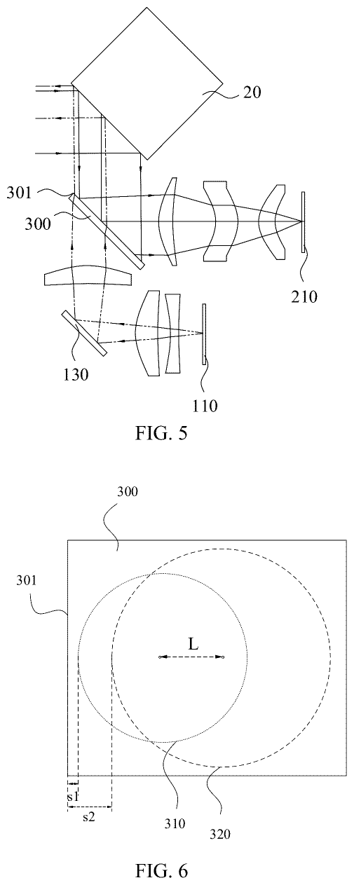

As shown in FIGS. 4 and 5, they are structural schematic diagrams of a light transceiving module 10 in an embodiment of the present application. The light transceiving module 10 includes a light emitting assembly 100, a light receiving assembly 200, and a beam splitter 300. The light emitting assembly 100 includes a light emitter 110 for emitting detecting light. The light emitting channel of the light emitting assembly 100 extends from the light emitter 110, passes through the beam splitter 300, and reaches the light scanning device 20. The light emitting assembly 100 is configured to emit detecting light toward a target object in the field of view along the light emitting channel. The light receiving assembly 200 includes a light receiver 210 for receiving echo light. The light receiving channel of the light receiving assembly 200 extends from the light scanning device 20, passes through the beam splitter 300, and reaches the light receiver 210. The light receiving assembly 200 is configured to receive echo light formed by reflection of the detecting light from the target object along the light receiving channel.

The light scanning device 20 has a working surface 21 facing the field of view. Light enters and exits the light scanning device 20 via the working surface 21. Specifically, the detecting light emitted by the light emitting assembly passes through the beam splitter 300 and is projected onto the working surface 21. The working surface 21 is configured to deflect the detecting light passing through the beam splitter 300 to the field of view for scanning, and also configured to receive the echo light and deflect the echo light to the beam splitter 300. The echo light passing through the beam splitter 300 is then projected to the light receiving assembly 200. The working surface 21 may be formed by a surface of a light reflecting structure of the light scanning device 20. For example, the light scanning device 20 includes a rotating mirror and a drive motor. The drive motor is connected to the rotating mirror to drive the rotation of the rotating mirror. The rotating mirror is used to deflect light, and the working surface 21 may be formed by the reflecting surface of the rotating mirror. The housing of the LiDAR 1 has a light-transmitting opening corresponding to the working surface 21 of the light scanning device 20. Light enters and exits the LiDAR 1 through the light-transmitting opening. The housing of the LiDAR 1 further includes a transparent protective plate, which is sealed at the light-transmitting opening to protect the light scanning device 20 and components mounted in the internal space of the housing.

The beam splitter 300 is disposed on the light emitting channel between the light emitting assembly 100 and the light scanning device 20, and also disposed on the light receiving channel between the light receiving assembly 200 and the light scanning device 20. The beam splitter 300 has a transparent region 310 through which the detecting light passes and a reflective region 320 that deflects the echo light, and configured to separate the light emitting channel and the light receiving channel. For example, the beam splitter 300 is used to separate the light emitting channel and the light receiving channel along two directions that are perpendicular or form an acute angle.

As shown in FIG. 4, the light emitting assembly 100 has an emitting aperture r1, which is the aperture of the minimum light-transmitting hole of the light emitting assembly 100 (for convenience of labeling, all apertures in the drawings are labeled with diameter R1, where r1=R1). The light receiving assembly 200 has a receiving aperture r2, which is the aperture of the minimum light-transmitting hole of the light receiving assembly 200 (for convenience of labeling, all apertures in the drawings are labeled with diameter R2, where r2=R2). The emitting aperture r1 and the receiving aperture r2 satisfy: r1<r2. The light receiving assembly 200 has a larger light-transmitting area, enabling the light receiving assembly 200 to receive as much echo light formed by reflection of the detecting light emitted by the light emitting assembly 100 from the target object as possible.

The light transceiving module 10 has a front-back direction. When the light transceiving module 10 is installed in the LiDAR 1, the front-back direction of the light transceiving module 10 is the same as that of the LiDAR 1. The light scanning device 20 is configured to deflect the detecting light and project it to the field of view toward the front side of the light transceiving module 10. Herein, the optical axis H1 of the light emitting assembly 100 and the optical axis H2 of the light receiving assembly 200 between the beam splitter 300 and the light scanning device 20 are parallel. At the beam splitter 300, the optical axis H1 of the light emitting assembly 100 is located at the front side of the optical axis H2 of the light receiving assembly 200, and the vertical distance between the optical axis H1 of the light emitting assembly 100 and the optical axis H2 of the light receiving assembly 200 at the beam splitter 300 is L, where 0<L<r1+r2. As shown in FIG. 4, this causes the light emitting assembly 100 and the light receiving assembly 200 to be in a slightly off-axis state. That is, the light receiving channel of the light emitting assembly 100 between the beam splitter 300 and the light scanning device 20 neither completely covers the light emitting channel of the light receiving assembly 200 nor is completely separated from the light emitting channel. Preferably, r2−r1<L<r2.

In the present application, the light emitting assembly 100 and the light receiving assembly 200 are in a slightly off-axis state. Compared with the coaxial optical path scheme, the receiving aperture r2 of the light receiving assembly 200 can be made smaller. Moreover, at the beam splitter 300, the optical axis of the light emitting assembly 100 is located at the front side of the optical axis of the light receiving assembly 200, causing the detecting light to pass through the beam splitter 300 in a region deviating from the center of the beam splitter 300. Consequently, when the detecting light passing through the beam splitter 300 is projected to the light scanning device 20 and reflected by the light scanning device 20 to be projected to the field of view, the probability that the detecting light is blocked by the beam splitter 300 is greatly reduced, and the probability that the detecting light is reflected by the beam splitter 300 to form stray light is also greatly reduced. This not only meets the demand for short-distance detection but also allows the distance between the beam splitter 300 and the light scanning device 20 to be shortened to compress the volume of the entire LiDAR 1. Compared with the off-axis optical path scheme, in the present application, in the region between the beam splitter 300 and the light scanning device 20, the vertical distance between the optical axis of the light emitting assembly 100 and the optical axis of the light receiving assembly 200 is reduced, thereby enabling the size of the working surface 21 of the light scanning device 20 used for deflecting the detecting light and the echo light to be reduced. The load and size of the drive motor for driving the movement of the working surface 21 of the light scanning device 20 can both be reduced, and the noise is also reduced. Secondly, in the off-axis optical path scheme, the large vertical distance between the optical axis of the light emitting assembly 100 and the optical axis of the light receiving assembly 200 causes the echo light (formed by reflection of the detecting light from the target object) to undergo multiple deflections before reaching the light receiving assembly 200, resulting in a large spot offset when the echo light arrives at the light receiving assembly 200. The larger the distance, the greater the spot offset. In the present application, shortening the vertical distance between the optical axis of the light emitting assembly 100 and the optical axis of the light receiving assembly 200 reduces the spot offset of the echo light arriving at the light receiving assembly 200, mitigating the influence of the spot offset on the detection effect of the LiDAR 1. In addition, in the present application, the size of the light receiving assembly 200 is between that of the coaxial optical path scheme and the off-axis optical path scheme. The production and assembly difficulty of the light receiving assembly 200 is moderate, facilitating mass production.

As shown in FIG. 4, the light transceiving module 10 comprises a first aperture stop 410. The first aperture stop 410 is located on the light emitting channel of the light emitting assembly 100 opposite to the beam splitter 300. The emitting aperture r1 of the light emitting assembly 100 is the aperture of the first aperture stop 410. The light transceiving module 10 comprises a second aperture stop 420. The second aperture stop 420 is located on the light receiving channel spaced apart from the light emitting channel. The receiving aperture r2 of the light receiving assembly 200 is the aperture of the second aperture stop 420.

In an embodiment of the present application, at least a part of the light emitting channel is arranged along a first direction M. The beam splitter 300 is disposed on the part of the light emitting channel arranged along the first direction A, and along the first direction M, the light scanning device 20 is located on the side of the beam splitter 300 away from the light emitting assembly 100. When the light transceiving module 10 is applied to a LiDAR, the LiDAR is installed in a mobile setting. The first direction M may be a direction forming an angle with the front-back direction of the LiDAR. For example, if the front-back direction of the LiDAR is horizontal, the first direction M may be vertical. A part of the light receiving channel is arranged along the first direction M, and the echo light projected along the first direction M is deflected by the beam splitter 300 and then projected along a second direction N forming an angle with the first direction M to the light receiving assembly 200, so as to separate another part of the light receiving channel from the light emitting channel.

Herein, in the region between the beam splitter 300 and the light scanning device 20, the optical axis of the light emitting assembly 100 and the optical axis of the light receiving assembly 200 are arranged along the first direction M and are parallel to each other. Both the optical axis of the light emitting assembly 100 and the optical axis of the light receiving assembly 200 pass through the beam splitter 300. Correspondingly, the vertical distance L between the optical axis of the light emitting assembly 100 and the optical axis of the light receiving assembly 200 at the beam splitter 300 is the vertical distance between the parts of the optical axis of the light emitting assembly 100 and the optical axis of the light receiving assembly 200 located between the beam splitter 300 and the light scanning device 20.

It can be understood that when the detecting light propagates in the light emitting channel, it may converge or diverge. Except for the detecting light on the optical axis of the light emitting assembly 100, the detecting light outside the optical axis of the light emitting assembly 100 forms an angle with the optical axis of the light emitting assembly 100. Similarly, when the echo light propagates in the light receiving channel, the echo light outside the optical axis of the light receiving assembly 200 forms an angle with the optical axis of the light receiving assembly 200. The cross-sectional range of the detecting light at the beam splitter 300 may differ from that at the first aperture stop 410. Likewise, the cross-sectional range of the echo light at the beam splitter 300 may differ from that at the second aperture stop 420. In the present application, shortening the vertical distance L between the optical axis of the light emitting assembly 100 and the optical axis of the light receiving assembly 200 causes the transparent region 310 and the reflective region 320 of the beam splitter 300 to partially overlap, which also helps reduce the size of the beam splitter 300.

In some embodiments, as shown in FIG. 6, the transparent region 310 and the reflective region 320 are both circular. The center of the circular transparent region 310 is the position of the optical axis H1 of the light emitting assembly 100, and the center of the circular reflective region 320 is the position of the optical axis H2 of the light receiving assembly 200. Herein, the centers of the transparent region 310 and the reflective region 320 are spaced apart. The reflective region 320 is located in the central region of the beam splitter 300, and the transparent region 310 is arranged deviating from the central region of the beam splitter 300. The reflective region 320 only partially covers the transparent region 310. The beam splitter 300 has a front edge 301. The part of the transparent region 310 not covered by the reflective region 320 is located between the front edge 301 and the reflective region 320. When the light transceiving module 10 is installed in the LiDAR 1, the front edge 301 is located at the front side of the reflective region 320.

Optionally, as shown in FIG. 6, a distance from an edge of the transparent region 310 to the front edge 301 is s1, a distance from an edge of the reflective region 320 to the front edge 301 is s2, s1<s2, and 0 mm≤s1≤5 mm. Within this distance range, when the light transceiving module 10 is installed in the LiDAR 1, the part of the beam splitter 300 located at the front side of the transparent region 310 is small, resulting in less obstruction of light. Moreover, since the reflective region 320 is far from the front edge 301, the reflective region 320 does not reflect the light reflected by the light scanning device 20, thereby effectively reducing the generation of stray light.

No limitation is imposed on the material of the beam splitter 300 in the embodiments of the present application; any material in the art that can be used as the beam splitter 300 is applicable to the present application.

The light emitting assembly 100 comprises an emitting lens group 120, a light emitter 110, an emitting circuit board, and an emitting housing. The light emitter 110 is disposed on the emitting circuit board, and the emitting circuit board is disposed on the emitting housing. Herein, the emitting lens group 120 is disposed on the emitting channel between the light emitter 110 and the beam splitter 300. The detecting light emitted by the light emitter 110 passes through the emitting lens group 120 to reach the beam splitter 300 and is projected to the light scanning device 20 after passing through the beam splitter 300. The emitting lens group 120 is configured to collimate the divergent detecting light emitted by the light emitter 110 and project it to the beam splitter 300, and the emitting lens group 120 comprises at least one collimating lens. The light receiving assembly 200 comprises a receiving lens group 220, a light receiver 210, a receiving circuit board, and a receiving housing. The light receiver 210 is disposed on the receiving circuit board, and the receiving circuit board is disposed on the receiving housing. Herein, the receiving lens group 220 is disposed on the receiving channel between the light receiver 210 and the beam splitter 300, so as to receive the echo light split by the beam splitter 300 and project the echo light to the light receiver 210. The receiving lens group 220 comprises at least one receiving lens, and the receiving lens is configured to focus the echo light onto the light receiver 210.

In the embodiments of the present application, the arrangement manner of the light emitting assembly 100 and the light receiving assembly 200 may include the following three schemes: Scheme A, Scheme B, and Scheme C.

Scheme A: Referring again to FIG. 4, the light emitter 110 is configured to emit detecting light along the second direction N. The light emitting assembly 100 further comprises an emitting reflector 130, which is disposed on the light emitting channel between the light emitter 110 and the beam splitter 300. The emitting reflector 130 is configured to deflect the detecting light emitted by the light emitter 110 along the second direction N and project the deflected detecting light along the first direction M to the beam splitter 300. The detecting light passing through the beam splitter 300 is projected along the first direction M to the light scanning device 20 and deflected by the light scanning device 20 to be projected to the field of view toward the front side of the LiDAR 1. The echo light from the field of view is deflected by the light scanning device 20 and projected along the first direction M to the beam splitter 300, then deflected by the beam splitter 300 and projected along the second direction N to the light receiver 210. The light receiver 210 is configured to receive the echo light projected along the second direction N after being deflected by the beam splitter 300, and the receiving lens group 220 is disposed on the light receiving channel between the light receiver 210 and the beam splitter 300.

Optionally, the emitting reflector 130 may be disposed on the light emitting channel between the beam splitter 300 and the emitting lens group 120; or, the emitting reflector 130 may be disposed between two adjacent lenses of the emitting lens group 120; or, the emitting reflector 130 may be disposed on the light emitting channel between the light emitter 110 and the emitting lens group 120.

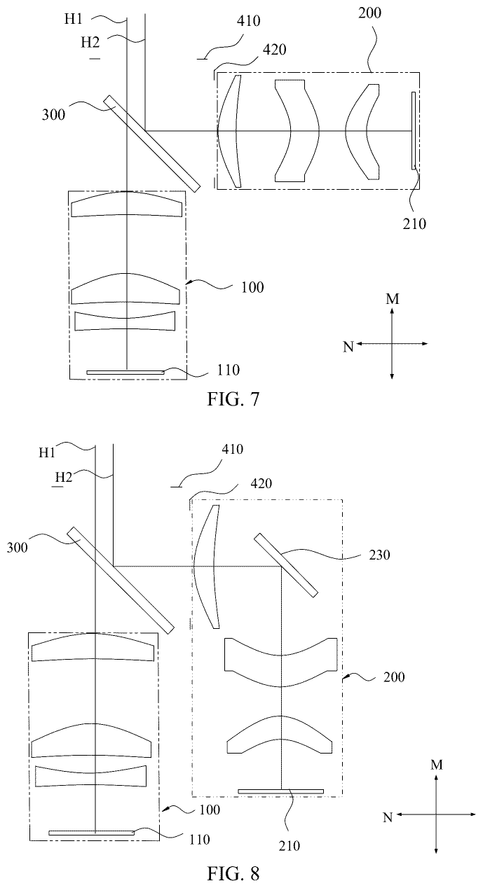

Scheme B: As shown in FIG. 7, the light emitter 110 is configured to emit detecting light along the first direction M. The detecting light emitted by the light emitter 110 passes through the beam splitter 300 and is projected along the first direction M to the light scanning device 20, then deflected by the light scanning device 20 to be projected to the field of view toward the front side of the LiDAR 1. The echo light from the field of view is deflected by the light scanning device 20 and projected along the first direction M to the beam splitter 300, then deflected by the beam splitter 300 and projected along the second direction N to the light receiver 210. The light receiver 210 is configured to receive the echo light projected along the second direction N after being deflected by the beam splitter 300, and the receiving lens group 220 is disposed on the light receiving channel between the light receiver 210 and the beam splitter 300.

Scheme C: As shown in FIG. 8, the light emitter 110 is configured to emit detecting light along the first direction M. The detecting light emitted by the light emitter 110 passes through the beam splitter 300 and is projected along the first direction M to the light scanning device 20, then deflected by the light scanning device 20 to be projected to the field of view toward the front side of the LiDAR 1. The light receiver 210 further comprises a receiving reflector 230, which is disposed on the light receiving channel between the light receiver 210 and the beam splitter 300. The receiving reflector 230 is configured to deflect the echo light projected along the second direction N after being deflected by the beam splitter 300 to be projected along the first direction M to the light receiver 210. The transmission path of the echo light along the receiving channel is as follows: the echo light from the field of view is deflected by the light scanning device 20 and projected along the first direction M to the beam splitter 300, then deflected by the beam splitter 300 and projected along the second direction N to the receiving reflector 230. The receiving reflector 230 deflects the echo light and projects it along the first direction M to the light receiver 210. The light receiver 210 is configured to receive the echo light projected along the first direction M after being deflected by the receiving reflector 230.

When the light receiver 210 further comprises the receiving reflector 230, the receiving reflector 230 may be disposed on the light receiving channel between the beam splitter 300 and the receiving lens group 220; or, the receiving reflector 230 may be disposed between two adjacent lenses of the receiving lens group 220; or, the receiving reflector 230 may be disposed on the light receiving channel between the light receiver 210 and the receiving lens group 220.

The following will introduce the assembly structure and corresponding implementation results of one specific embodiment of the light transceiving module for a LiDAR in the present technical solution with reference to the drawings and tables, combined with specific numerical values.

The meanings of the markings shown in each embodiment are as follows.

FS1, FS3, and FS5 are the numbering of the object-side surfaces of the first emitting lens FL1, the second emitting lens FL2, and the third emitting lens FL3 of the emitting lens group, respectively. FS2, FS4, and FS6 are the numbering of the image-side surfaces of the first emitting lens FL1, the second emitting lens FL2, and the third emitting lens FL3 of the emitting lens group, respectively.

JS1, JS3, and JS5 are the numbering of the object-side surfaces of the first receiving lens JL1, the second receiving lens JL2, and the third receiving lens JL3 of the receiving lens group, respectively. JS2, JS4, and JS6 are the numbering of the image-side surfaces of the first receiving lens JL1, the second receiving lens JL2, and the third receiving lens JL3 of the receiving lens group, respectively.

When the object-side surface or image-side surface of a lens in the emitting lens group or the receiving lens group is an even-order aspheric surface, the even-order aspheric surface satisfies the aspheric formula of Mathematical Formula 1:

$$Mathematical Formula 1$$

$$z = \frac{c {r}^{2}}{1 + \sqrt{1 - ( 1 + k ) {c}^{2} {r}^{2}}} + {A}_{2} {r}^{2} + {A}_{4} {r}^{4} + {A}_{6} {r}^{6} + {A}_{8} {r}^{8} + {A}_{10} {r}^{10} + {A}_{12} {r}^{12} + {A}_{14} {r}^{14} + {A}_{16} {r}^{16}$$

wherein, K is the conic constant (Conic Conant), “A2”, “A4”, “A6”, “A8”, “A10”, “A12”, “A14”, and “A16” represent the 2nd-order, 4th-order, 6th-order, 8th-order, 10th-order, 12th-order, 14th-order, and 16th-order aspheric coefficients, respectively; r is the distance from any point on the aspheric surface to the optical axis; c is the paraxial curvature at the vertex of the aspheric surface; Z is the vector height representing the distance from the vertex of the aspheric surface when the aspheric surface is at a height r along the optical axis direction.

### (I) Emitting Lens Group

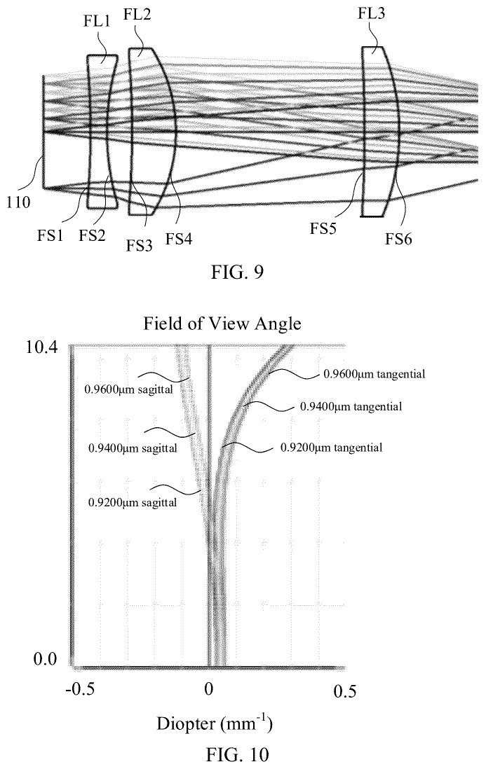

Referring to FIG. 9 for the structural schematic diagram of the emitting lens group in this embodiment, the emitting lens group comprises a first emitting lens FL1, a second emitting lens FL2, and a third emitting lens FL3 arranged sequentially along the optical axis from the image side to the object side.

Wherein, the first emitting lens FL1 has negative power, and the image-side surface FS3 and the object-side surface FS4 of the first emitting lens FL1 are both concave surfaces at the paraxial region. The second emitting lens FL2 has positive power, the image-side surface FS5 of the second emitting lens FL2 is a concave surface at the paraxial region, and the object-side surface FS6 is a convex surface at the paraxial region. The third emitting lens FL3 has positive power, the image-side surface FS7 of the third emitting lens FL3 is a concave surface at the paraxial region, and the object-side surface FS8 is a convex surface at the paraxial region.

In this embodiment, the effective focal length, refractive index, and Abbe number of the emitting lens group are referenced to light of wavelength 0.94 μm. The relevant parameters of the emitting lens group are shown in Table 1.

Wherein, the relevant parameters in Table 1 indicate: fn is the effective focal length of the emitting lens group, TTLn is the total optical length of the emitting lens group, and On is the vertical field of view angle of the emitting lens group.

Additionally, regarding the parameters in the column of thickness d in Table 1 and the following Table 2, each lens includes two thickness parameters listed vertically. The first thickness parameter of each lens is the thickness of the lens on the optical axis, and the second thickness parameter is the air distance between adjacent lenses in the optical axis direction.

TABLE 1
fn = 34.65 mm; θn = 26°;

| | | | Radius of | | | Abbe |
|---|---|---|---|---|---|---|
| | Surface | Surface | Curvature | Thickness | Refractive | Number |
| Name | Number | Type | R/mm | d/mm | Index nd | vd |
| Exit | — | — | Infinity | Infinity | — | — |
| Surface | | | | | | |
| First | FS1 | spherical | −149.4414 | 2.9998 | 1.5891 | 61.253 |
| Emitting | | surface | | | | |
| Lens | FS2 | spherical | 46.4762 | 4.5813 | | |
| FL1 | | surface | | | | |
| Second | FS3 | spherical | −171.8052 | 8.0009 | 1.8467 | 23.784 |
| Emitting | | surface | | | | |
| Lens | FS4 | spherical | −28.6257 | 34.4076 | | |
| FL2 | | surface | | | | |
| Third | FS5 | spherical | −250.0036 | 6.3352 | 1.6727 | 32.171 |
| Emitting | | surface | | | | |
| Lens | FS6 | spherical | −40.4883 | — | | |
| FL3 | | surface | | | | |
| Object | — | — | Infinity | 0.000 | — | — |
| Side | | | | | | |

FIG. 10 is a field curvature curve diagram of the emitting lens group in this embodiment. The diopters of the sagittal image plane and tangential image plane of the emitting lens group at various wavelengths in FIG. 10 are all within ±0.5 mm⁻¹, indicating that the astigmatism of the emitting lens group in this embodiment is small and the imaging quality is good.

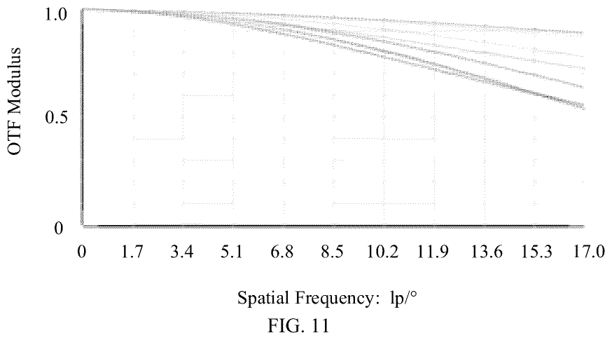

FIG. 11 is a modulation transfer function (MTF) curve diagram of the emitting lens group in this embodiment. FIG. 11 shows the MTF curves of the tangential image plane and sagittal image plane of the emitting lens group at field positions of 0.00 mm, 0.8 mm, 2.4 mm, 4.00 mm, 5.6 mm, 7.2 mm, 8.8 mm, and 10.4 mm, respectively. It can be found from FIG. 11 that the MTF value is >0.54 at a maximum resolution of 17 line pairs per degree (lp/°), indicating good imaging quality of the emitting lens group in this embodiment.

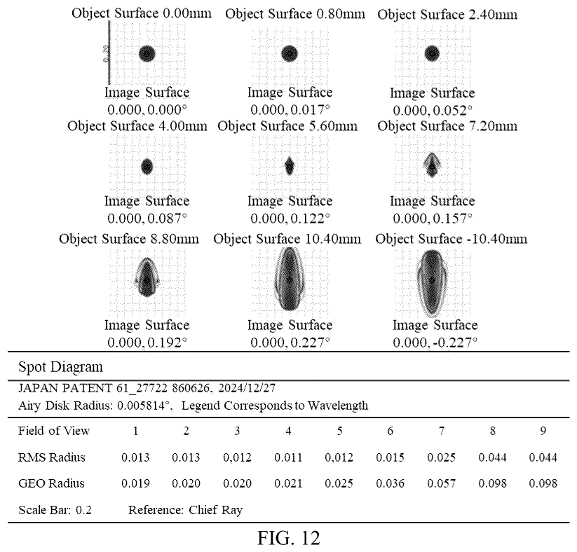

FIG. 12 is a full-field spot diagram of the emitting lens group, obtained through analysis by optical analysis software. It represents the distribution of intersection points of different rays at different field angles with the exit surface after passing through the emitting lens group. The smaller the diffusion spots in the spot diagram, the smaller the aberration. That is, the smaller the values of the RMS radius (root mean square radius) and GEO radius (diameter of all diffusion spots) below FIG. 12, the smaller the aberration, i.e., the higher the optical performance. From the data below FIG. 12, it can be seen that the RMS radius value is always controlled below 0.013°, indicating good optical performance of the light transceiving module.

In this embodiment, a sufficient air gap is designed between the second emitting lens FL2 and the third emitting lens FL3 for inserting an emitting reflector to facilitate the overall layout. Analyzing the system requirements of applying this emitting lens group to a LiDAR, the emitting lens group mainly focuses on sagittal MTF performance. The spot design of the emitting lens group is a vertical strip shape, with better horizontal emission divergence angle and better horizontal optical resolution of the LiDAR. Meanwhile, the vertical spot uniformity is improved, the echo energy is uniform, which is beneficial for calibration.

### (II) Receiving Lens Group

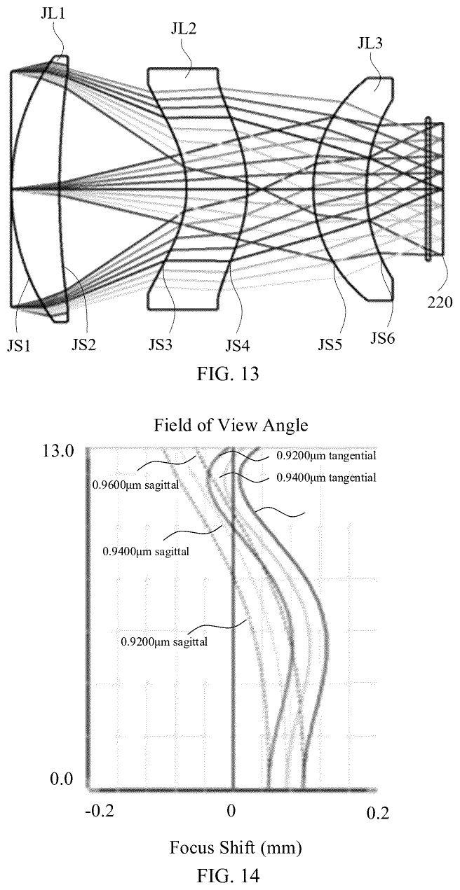

In this embodiment, referring to FIG. 13 for the structural schematic diagram of the receiving lens group, the receiving lens group comprises a first receiving lens JL1, a second receiving lens JL2, and a third receiving lens JL3 arranged sequentially along the optical axis from the object side to the image side, and the second aperture stop is disposed on the object-side surface JS1 of the first receiving lens JL1.

Wherein, the first receiving lens JL1 has positive power, the object-side surface JS1 of the first receiving lens JL1 is a convex surface at the paraxial region, and the image-side surface JS2 is a concave surface at the paraxial region. The second receiving lens JL2 has negative power, the object-side surface JS3 of the second receiving lens JL2 is a concave surface at the paraxial region, and the image-side surface JS4 is a convex surface at the paraxial region. The third receiving lens JL3 has positive power, the object-side surface JS5 of the third receiving lens JL3 is a convex surface at the paraxial region, and the image-side surface JS6 is a concave surface at the paraxial region.

In this embodiment, the effective focal length, refractive index, and Abbe number of the receiving lens group are referenced to light of wavelength 0.94 μm. The relevant parameters of the receiving lens group are shown in Table 2.

Wherein, the relevant parameters in Table 2 indicate: fm is the effective focal length of the receiving lens group, TTLm is the total optical length of the receiving lens group, and Om is the vertical field of view angle of the receiving lens group.

TABLE 2
fm = 1.74 mm; θm = 26°;

| | | | Radius of | | | Abbe |
|---|---|---|---|---|---|---|
| | Surface | Surface | Curvature | Thickness | Refractive | Number |
| Name | Number | Type | R/mm | d/mm | Index nd | vd |
| Object | — | — | Infinity | | — | — |
| Surface | | | | | | |
| Second | — | — | — | — | — | — |
| Aperture | | | | | | |
| Stop | | | | | | |
| First | JS1 | spherical | −149.4414 | 2.9998 | 1.5891 | 61.253 |
| Receiving | | surface | | | | |
| Lens JL1 | JS2 | spherical | 46.4762 | 4.5813 | | |
| | | surface | | | | |
| Second | JS3 | aspheric | −171.8052 | 8.0009 | 1.8467 | 23.784 |
| Receiving | | surface | | | | |
| Lens JL2 | JS4 | aspheric | −28.6257 | 34.4076 | | |
| | | surface | | | | |
| Third | JS5 | spherical | −250.0036 | 6.3352 | 1.6727 | 32.171 |
| Receiving | | surface | | | | |
| Lens JL3 | JS6 | spherical | −40.4883 | 9.1 | | |
| | | surface | | | | |
| Image | — | — | Infinity | 0.000 | — | — |
| Surface M | | | | | | |

In this embodiment, the conic constant K and the aspheric coefficients corresponding to the surfaces of each lens are shown in Table 3.

TABLE 3

| Aspheric | | |
|---|---|---|
| Coefficients | JS3 | JS4 |
| c | −6.2197562E−02 | −6.2197562E−02 |
| k | 1.0006240E−02 | −2.5555030E+00 |
| A2 | 0 | 0 |
| A4 | 8.1646075E−05 | −3.4022405E−05 |
| A6 | 7.8152650E−08 | 4.4397588E−07 |
| A8 | 5.3091104E−10 | −1.0726994E−09 |

In this embodiment, the second receiving lens JL2 is selected as an even-order aspheric lens. Using one second receiving lens JL2 can achieve the same optical performance as five spherical lenses, simplifying the structure of the receiving lens group and improving the tolerance resistance of the receiving lens group.

FIG. 14 is a field curvature curve diagram of the receiving lens group in this embodiment. The focus shifts of the sagittal image plane and tangential image plane of the receiving lens group at various wavelengths in FIG. 14 are all within ±0.16 mm, indicating that the astigmatism of the receiving lens group in this embodiment is small and the imaging quality is good.

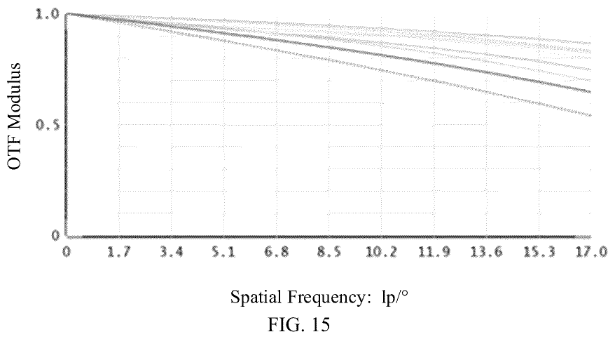

FIG. 15 is a modulation transfer function (MTF) curve diagram of the receiving lens group in this embodiment. FIG. 15 shows the MTF curves of the tangential image plane and sagittal image plane of the receiving lens group at field angle positions of 0.00 deg, 3.25 deg, 6.50 deg, 9.75 deg, and 13.00 deg, respectively. It can be found from FIG. 15 that the MTF value is >0.52 at a maximum resolution of 17 line pairs per millimeter (lp/mm), indicating good imaging quality of the receiving lens group in this embodiment.

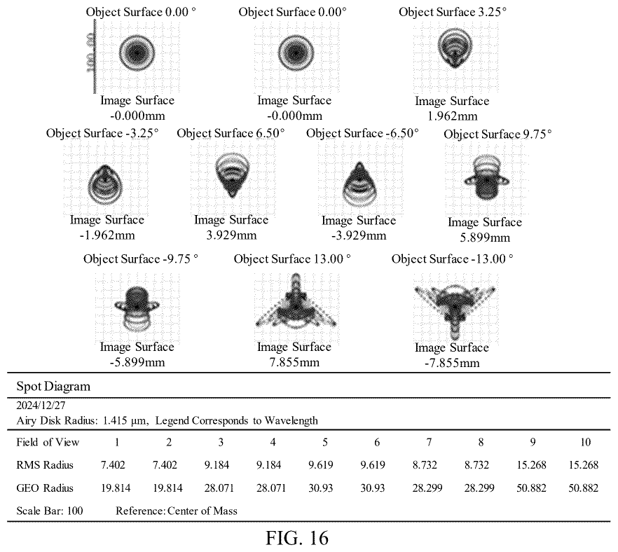

FIG. 16 is a full-field spot diagram of the receiving lens group. From the data below FIG. 16, it can be seen that the RMS radius value is always controlled below 51 μm, indicating good optical performance of the light transceiving module.

As can be seen from FIGS. 9 to 16, the light transceiving module in this embodiment can achieve good imaging effects.

In the drawings of this embodiment, identical or similar reference numerals correspond to identical or similar components. In the description of the present application, it should be understood that terms such as “upper,” “lower,” “left,” “right,” etc., indicating orientation or positional relationships are based on the orientation or positional relationships shown in the drawings, are merely for convenience of describing the present application and simplifying the description, and do not indicate or imply that the indicated devices or components must have a specific orientation, or be constructed and operated in a specific orientation. Therefore, the terms describing positional relationships in the drawings are only for illustrative purposes and shall not be construed as limiting the present patent. For a person of ordinary skill in the art, the specific meanings of the above terms can be understood according to specific circumstances.

The foregoing descriptions are merely preferred embodiments of the present application and are not intended to limit the present application. Any modifications, equivalent substitutions, improvements, etc., made within the spirit and principle of the present application shall fall within the protection scope of the present application.

What is claimed is:

1. A light transceiving module, for a LiDAR, comprising:
a light emitting assembly, configured to emit detecting light toward a target object along a light emitting channel;
a light receiving assembly, configured to receive echo light formed by reflection of the detecting light from the target object along a light receiving channel; and
a beam splitter, having a transparent region through which the detecting light passes and a reflective region that deflects the echo light, and configured to separate the light emitting channel and the light receiving channel;
wherein an emitting aperture of the light emitting assembly is r1, a receiving aperture of the light receiving assembly is r2, at the beam splitter, an optical axis of the light emitting assembly is located at a front side of an optical axis of the light receiving assembly, a vertical distance between the optical axis of the light emitting assembly and the optical axis of the light receiving assembly is L, r1<r2, and 0<L<r1+r2.

2. The light transceiving module according to claim 1, wherein
the light transceiving module comprises a first aperture stop, the first aperture stop being positioned on the light emitting channel of the beam splitter facing away from the light emitting assembly, wherein the emitting aperture of the light emitting assembly is an aperture of the first aperture stop; and
the light transceiving module comprises a second aperture stop, the second aperture stop being positioned on the light receiving channel spaced apart from the light emitting channel, wherein the receiving aperture of the light receiving assembly is an aperture of the second aperture stop.

3. The light transceiving module according to claim 1, wherein the light transceiving module satisfies: r2−r1<L<r2.

4. The light transceiving module according to claim 1, wherein
the transparent region and the reflective region partially overlap; and
the beam splitter has a front edge, a distance from an edge of the transparent region to the front edge of the beam splitter is s1, a distance from an edge of the reflective region to the front edge of the beam splitter is s2, s1<s2, and 0 mm≤s1≤5 mm.

5. The light transceiving module according to claim 1, wherein
at least a part of the light emitting channel is arranged along a first direction, and the beam splitter is disposed on the part of the light emitting channel arranged along the first direction; and
a part of the light receiving channel is arranged along the first direction, and the echo light projected along the first direction is deflected by the beam splitter into the light receiving channel to propagate along a second direction at an angle to the first direction toward the light receiving assembly, so as to separate another part of the light receiving channel from the light emitting channel.

6. The light transceiving module according to claim 5, wherein
the light emitting assembly comprises a light emitter, an emitting lens group, and an emitting reflector, the light emitter is configured to emit detecting light along the second direction;
the emitting lens group and the emitting reflector are respectively disposed on the light emitting channel between the light emitter and the beam splitter, the emitting reflector is configured to deflect the detecting light emitted by the light emitter along the second direction and project the deflected detecting light along the first direction to the beam splitter; and
the light receiver is configured to receive the echo light projected along the second direction after being deflected by the beam splitter, and the receiving lens group is disposed on the light receiving channel between the light receiver and the beam splitter.

7. The light transceiving module according to claim 6, wherein
the emitting reflector is disposed on the light emitting channel between the beam splitter and the emitting lens group; or,
the emitting reflector is disposed between two adjacent lenses of the emitting lens group; or,
the emitting reflector is disposed on the light emitting channel between the light emitter and the emitting lens group.

8. The light transceiving module according to claim 5, wherein
the light emitting assembly comprises a light emitter and an emitting lens group, the light emitter is configured to emit detecting light along the first direction, and the emitting lens group is disposed on the light emitting channel between the light emitter and the beam splitter;
the light receiving assembly comprises a light receiver and a receiving lens group, the receiving lens group is disposed on the light receiving channel between the light receiver and the beam splitter; and
the light receiver is configured to receive the echo light projected along the second direction after being deflected by the beam splitter.

9. The light transceiving module according to claim 5, wherein
the light emitting assembly comprises a light emitter and an emitting lens group, the light emitter is configured to emit detecting light along the first direction, and the emitting lens group is disposed on the light emitting channel between the light emitter and the beam splitter;
the light receiving assembly comprises a light receiver and a receiving lens group, the receiving lens group is disposed on the light receiving channel between the light receiver and the beam splitter; and
the light receiver further comprises a receiving reflector, the receiving reflector is disposed on the light receiving channel between the light receiver and the beam splitter, and the receiving reflector is configured to deflect the echo light projected along the second direction after being deflected by the beam splitter to be projected along the first direction to the light receiver.

10. A LIDAR, comprising:
the light transceiving module according to claim 1; and
a light scanning device having a working surface facing a field of view;
wherein the working surface is configured to deflect the detecting light passing through the beam splitter to the field of view for scanning, and also configured to receive the echo light and deflect the echo light to the beam splitter.
